(19) United States
(12) Patent Application Publication
(10) Pub. No.: US 2006/0133776 A1
(43) Pub. Date: Jun. 22, 2006

(54) Disk reproducing apparatus and information reproducing apparatus

(75) Inventors: Shigeru Toji, Osaka (JP); Nobunori Mantani, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/311,339

(22) Filed: Dec. 20, 2005

(30) Foreign Application Priority Data
Dec. 21, 2004 (JP) P2004-369952
Dec. 21, 2004 (JP) P2004-369953

(51) Int. Cl. H04N 7/52

(52) U.S. Cl. 386/96

(57) ABSTRACT

An information reproducing apparatus for reproducing an audio file and a still picture file recorded in a recording medium capable of recording the audio file and the still picture file, includes a reading unit that reads audio and still picture folders containing audio and still picture files recorded in the recording medium, a first display unit that displays lists of audio and still picture folders read by the reading unit on a left screen, a first selection unit that selects audio and still picture folders from the lists of the audio and still picture folders displayed by the first display unit, a second display unit that displays the audio and still picture folders selected by the first selection unit on a right screen, and a reproduction unit that reproduces simultaneously the audio and still picture files within the audio and still picture folders selected by the first selection unit.

### BACKGROUND OF THE INVENTION

1. Field of the Invention

The present invention relates to a disk reproducing apparatus and an information reproducing apparatus for reproducing the information recorded in a recording medium such as DVD (Digital Versatile Disc) capable of recording an audio file and a still picture file. More particularly, the invention relates to a disk reproducing apparatus and an information reproducing apparatus for simultaneously reproducing an audio file and a still picture file recorded in a recording medium such as DVD.

2. Description of the Related Art

Conventionally, the information reproducing apparatus such as a disk device that reproduce an audio file such as an MP3 (Moving Picture Coding Experts Group Audio Layer 3) file or a still picture file such as a JPEG (Joint Photographic Coding Experts Group) file recorded in a recording medium such as DVD can reproduce the audio file and the still picture file as desired by the user. However, there was a problem that the user could not enjoy reproducing the selected audio file and still picture file simultaneously by selecting the audio file and the still picture file as desired, because the audio file and the still picture file recorded in the recording medium such as DVD were reproduced simultaneously when the user reproduced the audio file such as MP3 file and the still picture file such as JPEG file simultaneously. Moreover, there was a problem that an audio file and a still picture file in the selected folders could not be reproduced simultaneously by selecting an audio folder such as an MP3 folder and a still picture folder such as a JPEG folder recorded in an optical disk.

There was a problem that when the audio file such as MP3 file and the still picture file such as JPEG file recorded in the recording medium such as DVD have different reproduction time, the file having a shorter reproduction time is ended earlier during simultaneous reproduction of the audio file and the still picture file, and the file having a longer reproduction time is only reproduced, so that the simultaneous reproduction of the audio file and the still picture file can not be continued.

In the related art, there was a technique of displaying the still pictures in the before/next display, random display or program display by acquiring a display time of the still picture number corresponding to the still picture from the management information and making the time search using the display time (e.g., refer to JP-A-2003-333508).

Also, there was a technique of reproducing each data of video, audio and still picture based on a play-list of reproducing the video, audio and still picture simultaneously by recording the play-list in the same recording medium as each data of video, audio and still picture (e.g., refer to JP-A-2003-264793).

Also, there was a technique of defining the cell for a piece of music or a reproduction unit below the piece of music to reproduce the sound, recording the cell information with the reproduction relation between music and picture information in the recording medium, and designating the picture information in terms of the cell information in reproducing the sound information for each piece of music including the cell information (e.g., refer to JP-A-2001-101831).

Also, there was a technique of displaying the still picture by reading the record data from an optical disk, storing the still picture data read from the record data in a still picture data storage section, and reading the still picture data stored in the still picture data storage section in reproducing the record data of the optical disk (e.g., refer to JP-A-2000-293925).

However, with the first technique as described in the related art, though it was possible to display the still pictures in the before/next display, random display or program display by acquiring a display time of the still picture number corresponding to the still picture from the management information and making the time search using the display time, the user could switch the still pictures at will without violating the standard during reproduction of sequential tracks in a slide show, but the above-mentioned problem was not solved.

Also, with the following technique, though it was possible to reproduce each data of video, audio and still picture based on a play-list of reproducing the video, audio and still picture simultaneously by recording the play-list in the same recording medium as each data of video, audio and still picture, there was a problem that the play-list of reproducing the video, audio and still picture simultaneously had to be created every time, and recorded in the same recording medium as each data of the video, audio and still picture.

Also, with the further technique, though it was possible to make the reproduction by defining the cell for a piece of music or a reproduction unit below the piece of music to reproduce the sound, recording the cell information with the reproduction relation between music and picture information in the recording medium, and designating the picture information in terms of the cell information in reproducing the sound information for each piece of music including the cell information, there was a problem that when the sound information was reproduced, the cell information with the reproduction relation between music and picture information to be reproduced had to be created every time and recorded in the recording medium together with the picture information.

Also, with the further technique, though it was possible to display the still picture by reading the record data from an optical disk, storing the still picture data read from the record data in a still picture data storage section, and reading the still picture data stored in the still picture data storage section in reproducing the record data of the optical disk, there was a problem that the still picture data displayed during reproduction of the optical disk had to be stored in the still picture data storage section.

### SUMMARY OF THE INVENTION

The invention has been achieved in the light of the above-mentioned problems associated with the related art, and the invention provides a disk reproducing apparatus and an information reproducing apparatus that can reproduce simultaneously an audio file and a static picture file within an audio folder and a static picture folder by selecting the audio folder and the static picture folder including the audio file and the static picture file recorded in a recording medium such as a DVD capable of recording the audio file such as MP3 file and the static picture file such as JPEG file.

The invention has been achieved in the light of the above-mentioned problems associated with the related art, and the invention provides a disk reproducing apparatus and an information reproducing apparatus that can continue to reproduce simultaneously an audio file such as an MP3 file and a static picture file such as a JPEG file recorded in a recording medium such as a DVD capable of recording the audio file and still picture file, in which when the reproduction of one of the files is ended during simultaneous reproduction of the audio file and the still picture file, the reproduction of the one file that ends reproduction ahead is repeated until the reproduction of the other file is ended.

According to an aspect of the present invention, an information reproducing apparatus for reproducing an audio file and a still picture file recorded in a recording medium capable of recording the audio file and the still picture file, includes a reading unit that reads a audio folder and a still picture folder containing an audio file and a still picture file recorded in the recording medium, a first display unit that displays a list of an audio folder and a list of a still picture folder read by the reading unit on a left screen, a first selection unit that selects an audio folder and a still picture folder from the list of the audio folder and the list of the still picture folder displayed by the first display unit, a second display unit that displays the audio folder and the still picture folder selected by the first selection unit on a right screen, and a reproduction unit that reproduces simultaneously the audio file and the still picture file within the audio folder and the still picture folder selected by the first selection unit.

According to another aspect of the present invention, the information reproducing apparatus further includes a second selection unit that selects the audio folder and the still picture folder displayed on the right screen by the second display unit, and a third display unit that displays the audio file and the still picture file within the audio folder and the still picture folder selected by the second selection unit on the right screen.

According to still another aspect of the present invention, the information reproducing apparatus, further includes a third selection unit that selects the audio file and the still picture file displayed by the third display unit, and a deletion unit that deletes the audio file and the still picture file selected by the third selection unit from a reproduction list. The reproduction unit reproduces simultaneously an audio file and a still picture file not deleted from the reproduction list by the deletion unit within the audio folder and the still picture folder selected by the first selection unit.

With these means, it is possible to reproduce simultaneously the audio file and the still picture file within the audio folder and the still picture folder by selecting the audio folder and the still picture folder containing the audio file and the still picture file recorded in the recording medium such as DVD capable of recording the audio file such as MP3 file and the still picture file such as JPEG file.

According to still another aspect of the present invention, an information reproducing apparatus that reproduces simultaneously an audio file and a still picture file recorded in a recording medium capable of recording the audio file and the still picture file, includes a reproduction unit that reproduces the audio file and the still picture file recorded in the recording medium, a display unit that displays the still picture file reproduced by the reproduction unit in a slide show while reproducing the audio file recorded in the recording medium, and a continuation unit that continues the slide show of the still picture file by repeating a reproduction of the still picture file recorded in the recording medium until a reproduction of the audio file recorded in the recording medium is ended, if the reproduction of the still picture file recorded in the recording medium is ended during a reproduction of the audio file and the still picture file.

According to yet another aspect of the present invention, in the information reproducing apparatus, the continuation unit resumes the reproduction of the still picture file recorded in the recording medium from an initial position, if the reproduction of the still picture file recorded in the recording medium is ended during the reproduction of the audio file and the still picture file.

According to still another aspect of the present invention, an information reproducing apparatus that reproduces simultaneously an audio file and a still picture file recorded in a recording medium capable of recording the audio file and the still picture file, includes a reproduction unit that reproduces the audio file and the still picture file recorded in the recording medium, a display unit that displays the still picture file reproduced by the reproduction unit in a slide show while reproducing the audio file recorded in the recording medium, and a continuation unit that continues a reproduction of the audio file by repeating the reproduction of the audio file recorded in the recording medium, until a reproduction of the still picture file recorded in the recording medium is ended, if the reproduction of the audio file recorded in the recording medium is ended during a reproduction of the audio file and the still picture file.

According to still another aspect of the present invention, in the information reproducing apparatus, the continuation unit resumes the reproduction of the audio file recorded in the recording medium from an initial position, if the reproduction of the audio file recorded in the recording medium is ended during the reproduction of the audio file and the still picture file.

According to a first aspect of the present embodiment, since a disk reproducing apparatus reads an MP3 folder and a JPEG folder containing an MP3 file and a JPEG file recorded in an optical disk, displays a list of MP3 folders and a list of JPEG folders read on a left screen, selects an MP3 folder and a JPEG folder from the list of MP3 folders and the list of JPEG folders displayed on the left screen, displays the selected MP3 folder and JPEG folder on a right screen, selects the MP3 folder and the JPEG folder displayed on the right screen, displays an MP3 file and a JPEG file within the MP3 folder and the JPEG folder selected on the right screen, selects the MP3 file and the JPEG file displayed on the right screen, deletes the selected MP3 file and JPEG file from a reproduction list, and reproduces simultaneously the MP3 file and the JPEG file not deleted from the reproduction list within the selected MP3 folder and JPEG folder, it is possible to reproduce simultaneously the MP3 file and the JPEG file within the MP3 folder and the JPEG folder by selecting the MP3 folder and the JPEG folder containing the MP3 file and the JPEG file recorded in the optical disk, whereby the MP3 file and the JPEG file desired to reproduce simultaneously within the MP3 folder and the JPEG folder can be selected.

According to a second aspect of the present embodiment, since an information reproducing apparatus reads an audio folder and a still picture folder containing an audio file and a still picture file recorded in a recording medium, displays a list of audio folders and a list of still picture folders read on a left screen, selects an audio folder and a still picture folder from the list of audio folders and the list of still picture folders displayed on the left screen, displays the selected audio folder and still picture folder on a right screen, and reproduces simultaneously the audio file and the still picture file within the selected audio folder and still picture folder, it is possible to reproduce simultaneously the audio file and the still picture file within the audio folder and the still picture folder by selecting the audio folder and the still picture folder containing the audio file and the still picture file recorded in the optical disk.

According to a third aspect of the present embodiment, since the information reproducing apparatus selects the audio folder and the still picture folder displayed on the right screen, and displays the audio file and the still picture file within the selected audio folder and still picture folder on the right screen, the audio file and the still picture file contained within the selected audio folder and still picture folder can be easily known.

According to a fourth aspect of the present embodiment, the information reproducing apparatus selects the audio file and the still picture file displayed on the right screen, deletes the selected audio file and still picture file from the reproduction list, and reproduces simultaneously the audio file and the still picture file not deleted from the reproduction list within the selected audio folder and still picture folder, it is possible to select the audio file and still picture file desired to reproduce simultaneously within the audio folder and still picture folder.

According to a fifth aspect of the present embodiment, since a disk reproducing apparatus reproduces an MP3 file and a JPEG file recorded in the optical disk, displays the reproduced JPEG file in a slide show while reproducing the MP3 file recorded in the optical disk, and continues the slide show of the JPEG file by resuming the reproduction of the JPEG file recorded in the optical disk from the initial position to repeat the reproduction of the JPEG file recorded in the optical disk until the reproduction of the MP3 file recorded in the optical disk is ended, if the reproduction of the JPEG file recorded in the optical disk is ended during reproduction of the MP3 file and the JPEG file, and continues the reproduction of the MP3 file by resuming the reproduction of the MP3 file recorded in the optical disk from the initial position until the reproduction of the JPEG file recorded in the optical disk is ended, if the reproduction of the MP3 file recorded in the optical disk is ended, it is possible to continue the simultaneous reproduction of the MP3 file and the JPEG file in such a way that when the reproduction of one of the files is ended during simultaneous reproduction of the MP3 file and the JPEG file recorded in the optical disk, the reproduction of the one file that ends reproduction ahead is repeated until the reproduction of the other file is ended.

According to a sixth aspect of the present embodiment, since an information reproducing apparatus reproduces an audio file and a still picture file recorded in a recording medium, displays the reproduced still picture file in a slide show while reproducing the audio file recorded in the recording medium, and continues the slide show of the still picture file by repeating the reproduction of the still picture file recorded in the recording medium until the reproduction of the audio file recorded in the recording medium is ended, if the reproduction of the still picture file recorded in the recording medium is ended during reproduction of the audio file and the still picture file, it is possible to continue the simultaneous reproduction of the audio file and the still picture file in such a way that when the reproduction of the still picture file is ended during simultaneous reproduction of the audio file and the still picture file recorded in the recording medium, the reproduction of the still picture file is repeated until the reproduction of the audio file is ended.

According to a seventh aspect of the preset embodiment, since the information reproducing apparatus resumes the reproduction of the still picture file recorded in the recording medium from the initial position, if the reproduction of the still picture file recorded in the recording medium is ended during reproduction of the audio file and the still picture file, it is possible to repeat the reproduction of the still picture file that ends reproduction ahead from the initial position.

According to a eighth aspect of the present embodiment, since an information reproducing apparatus reproduces an audio file and a still picture file recorded in a recording medium, displays the reproduced still picture file in a slide show while reproducing the audio file recorded in the recording medium, and continues the reproduction of the audio file by repeating the reproduction of the audio file recorded in the recording medium, until the reproduction of the still picture file recorded in the recording medium is ended, if the reproduction of the audio file recorded in the recording medium is ended during reproduction of the audio file and the still picture file, it is possible to continue the simultaneous reproduction of the audio file and the still picture file in such a way that when the reproduction of the audio file is ended during simultaneous reproduction of the audio file and the still picture file recorded in the recording medium, the reproduction of the audio file is repeated until the reproduction of the still picture file is ended.

According to a ninth aspect of the present embodiment, since the information reproducing apparatus resumes the reproduction of the audio file recorded in the recording medium from the initial position, if the reproduction of the audio file recorded in the recording medium is ended during reproduction of the audio file and the still picture file, it is possible to repeat the reproduction of the audio file that ends reproduction ahead from the initial position.

### BRIEF DESCRIPTION OF THE DRAWINGS

FIG. 1 is a block diagram showing the configuration of a disk reproducing apparatus according to one embodiment of the present invention;

FIG. 2 is an explanatory view showing a remote controller of the disk reproducing apparatus according to one embodiment of the invention;

FIG. 3 is an explanatory view showing the display examples of a selection screen for the disk reproducing apparatus according to one embodiment of the invention;

FIG. 4 is a flowchart showing the operation of the disk reproducing apparatus according to one embodiment of the invention;

FIG. 5 is a block diagram showing the configuration of a disk reproducing apparatus according to another embodiment of the present invention;

FIG. 6 is a flowchart showing the operation of the disk reproducing apparatus according to another embodiment of the invention; and

FIG. 7 is a flowchart showing the operation of the disk reproducing apparatus according to another embodiment of the invention.

### DETAILED DESCRIPTION OF THE INVENTION

### FIRST EMBODIMENT

The best mode for carrying out the present invention will be described below with reference to the accompanying drawings.

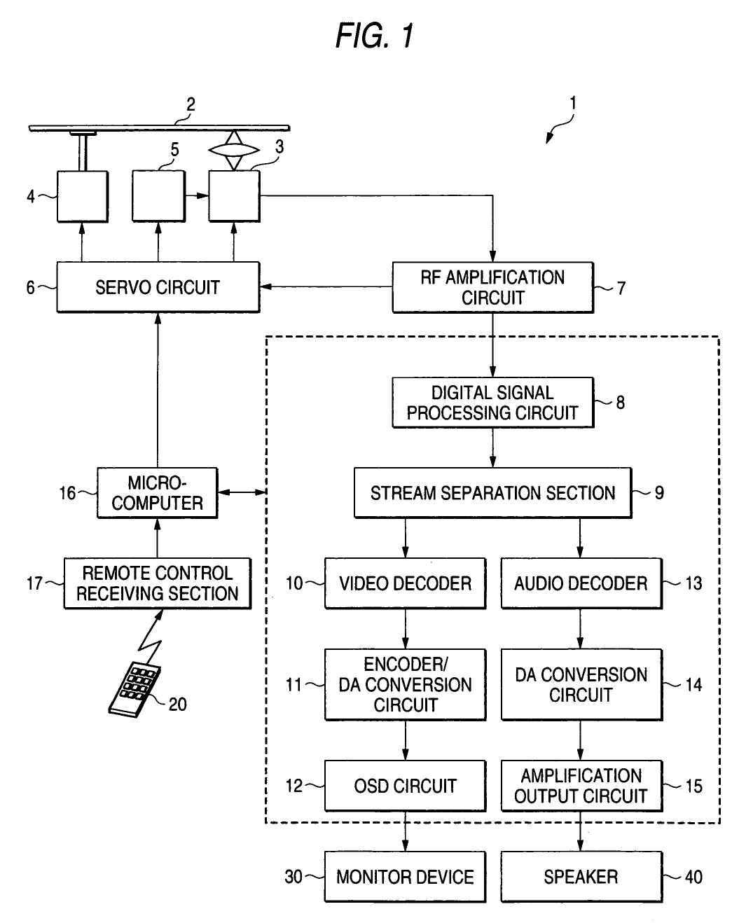

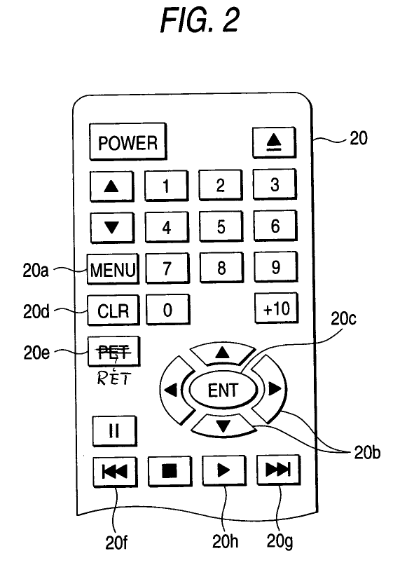

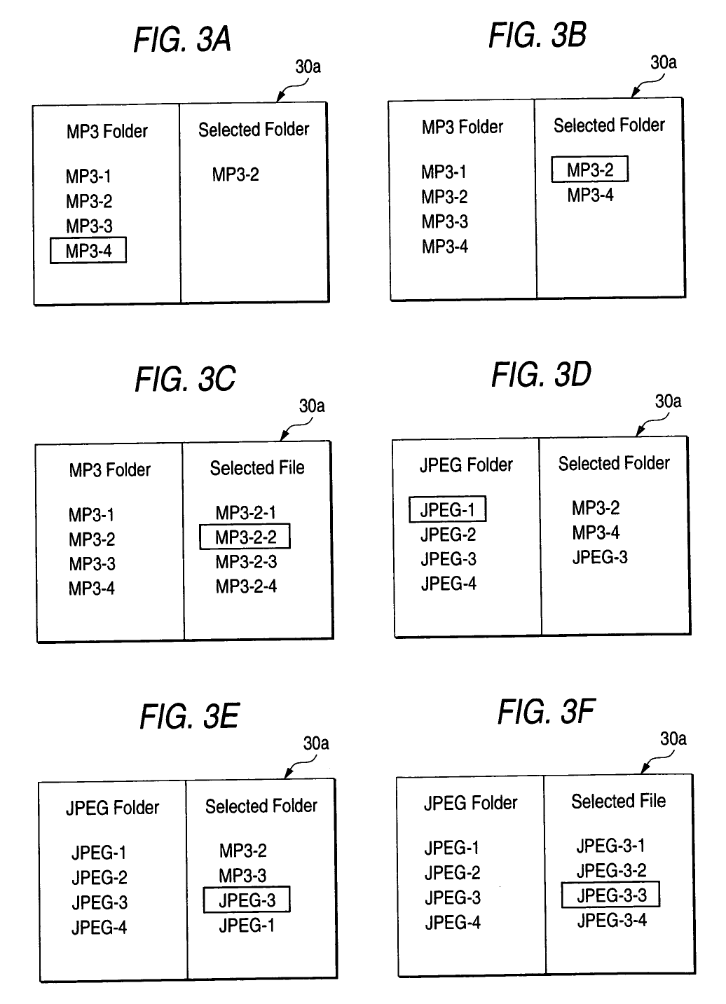

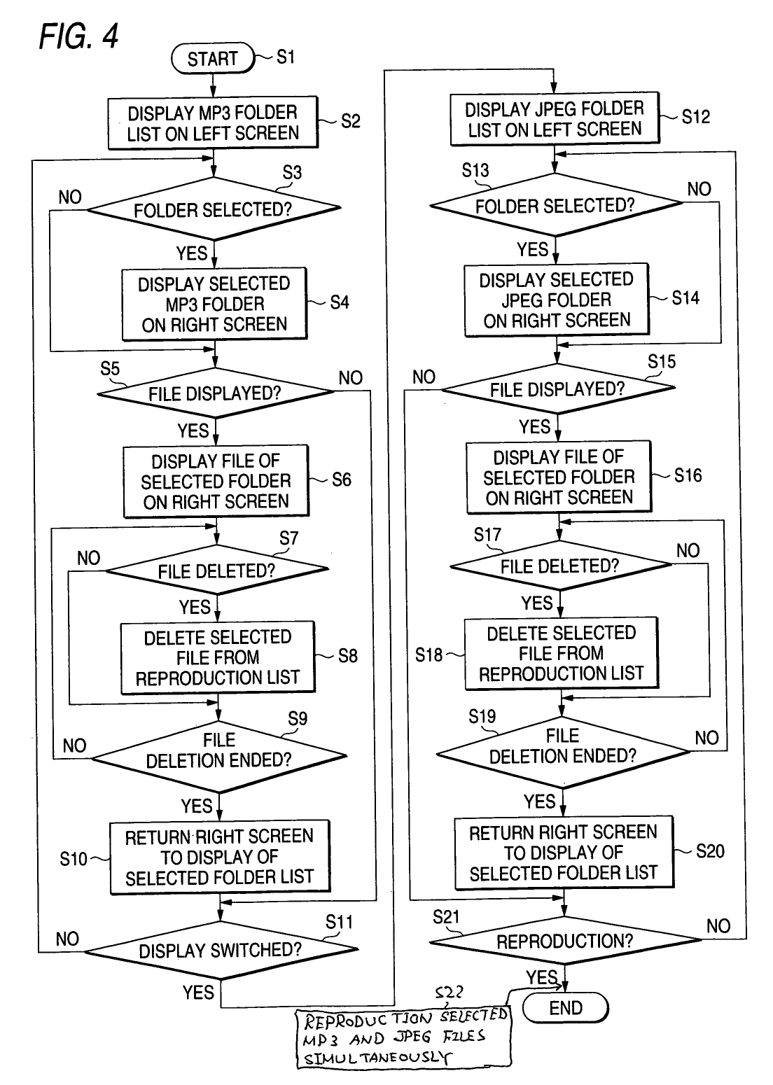

FIG. 1 is a block diagram showing the configuration of a disk reproducing apparatus according to one embodiment of the invention. FIG. 2 is an explanatory view showing a remote controller of the disk reproducing apparatus according to one embodiment of the invention. FIG. 3 is an explanatory view showing the display examples of a selection screen for the disk reproducing apparatus according to one embodiment of the invention. FIG. 4 is a flowchart showing the operation of the disk reproducing apparatus according to one embodiment of the invention.

Referring to the block diagram of FIG. 1, first of all, the configuration of the disk reproducing apparatus according to one embodiment of the invention will be described below.

The disk reproducing apparatus 1 includes an optical pickup 3 for reading the information data recorded in an optical disk 2 by applying a laser light onto a record face of the optical disk 2 and detecting its reflected light, a spindle motor 4 for rotating the optical disk 2, a sled motor 5 for moving the optical pickup 3 in the radial direction of the optical disk 2, a servo circuit 6 for making the servo control for the rotation rate of the optical disk 2, the servo control for the rotation direction and rotation speed of the sled motor 5, the servo control for the tracking of the optical pickup 3 based on a tracking error signal detected by the optical pickup 3, and the servo control for the focus of the optical pickup 3 based on a focus error signal detected by the optical pickup 3 by driving the spindle motor 4, an RF amplification circuit 7 for amplifying an RF (Radio Frequency) signal of the information data read by the optical pickup 3, a digital signal processing circuit 8 for converting the information data of an analog signal into a digital signal by detecting the RF signal of the information data amplified by the RF amplification circuit 7 in synchronism with a reference clock and demodulating the information data converted into the digital signal to correct an error of the demodulated information data, a stream separation section 9 for separating each bit stream of a video signal and an audio signal of the information data, a video decoder 10 for decoding the video signal into the original information data by expanding the video signal of the information data compressed in accordance with a predetermined compression method such as a JPEG method, an encoder/DA conversion circuit 11 for encoding the video signal of the digital signal decoded by the video decoder 10 into the video signal in accordance with a predetermined signal method such as an NTSC (National Television System Committee) method, and converting the encoded video signal of the digital signal into the analog signal, an OSD (On-Screen Character Display) circuit 12 for displaying the character information on the screen of a monitor device 30 by superposing a character information signal on the video signal, an audio decoder 13 for decoding the audio signal into the original digital signal by expanding the audio signal of the information data compressed in accordance with a predetermined compression method such as an MP3 method, a DA conversion circuit 14 for converting the decoded audio signal of the digital signal into the analog signal to drive a speaker 40, an amplification output circuit 15 for amplifying and outputting the audio signal, a microcomputer 16 for controlling the entire system of the disk reproducing apparatus 1, and a remote control receiving section 17 for receiving a remote control signal of an infrared signal transmitted from the remote controller 20 and converting it into a predetermined electrical signal.

Also, the remote controller 20 is provided with a plurality of operation keys, including a menu key 20a for commanding the switching between an MP3 folder (audio folder) and a JPEG folder (still picture folder) as well as commanding the display of a menu screen, a cursor key 20b for selecting a selection item displayed on the menu screen, an enter key 20c for deciding the selection of the selection item selected by the cursor key 20b, a clear key 20d for deleting the folder and the file selected by the cursor key 20b, a return key 20e for restoring the display of the selection screen and others to the original screen display, a forward skip key 20f/next skip key 20g for switching the selection between the left screen and the right screen of the monitor device 30, and a reproduction key 20h for commanding the reproduction of the optical disk, as shown in FIG. 2. The disk reproducing apparatus 1 is operated as desired by operating these operation keys.

The operation of the disk reproducing apparatus as constituted above will be described below.

If the setting of simultaneous reproduction of the menu screen (not shown) is selected by operating the cursor key 20b and the enter key 20c of the remote controller 20, and the display of the MP3 folder is selected by operating the menu key 20a of the remote controller 20, the microcomputer 16 sends out a control signal to the servo circuit 6 to drive the spindle motor 4 to rotate the optical disk 2, and drive the sled motor 5 to move the optical pickup 3 to read the MP3 folder (audio folder) and the JPEG folder (still picture folder) containing the MP3 file (audio file) and the JPEG file (still picture file) recorded in the optical disk 2 through the optical pickup 3, and sends out a control signal to the OSD circuit 12 to display a list of MP3 folders (audio folders) containing the MP3 files recorded in the optical disk 2 on the left screen of the screen 30a of the monitor device 30 (see FIG. 3A). If the MP3 folder displayed on the left screen of the screen 30a of the monitor device 30 is selected by operating the cursor key 20b and the enter key 20c of the remote controller 20, the microcomputer 16 sends out a control signal to the OSD circuit 12 to display the selected MP3 folder in a selected folder list on the right screen of the screen 30a of the monitor device 30 (see FIG. 3B). If the MP3 folder is contained in any JPEG folder, the JPEG folder is also displayed in the list of MP3 folders.

If the selected folder list displayed on the right screen of the screen 30a of the monitor device 30 is selected by operating the next skip key 20g of the remote controller 20, and the display of the MP3 file within the MP3 folder displayed on the right screen of the screen 30a of this monitor device 30 is commanded by operating the cursor key 20b and the enter key 20c of the remote controller 20, the microcomputer 16 sends out a control signal to the OSD circuit 12 to display the MP3 files within the selected MP3 folder on the right screen of the screen 30a of the monitor device 30 (see FIG. 3C). If the deletion of the MP3 file displayed on the right screen of the screen 30a of the monitor device 30 is commanded by operating the cursor key 20b and the clear key 20d of the remote controller 20, the microcomputer 16 sends out a control signal to the OSD circuit 12 to delete the selected MP3 file from the reproduction list. Also, if the end of deletion of the MP3 file is commanded by operating the return key 20e of the remote controller 20, the microcomputer 16 sends out a control signal to the OSD circuit 12 to return the right screen of the screen 30a of the monitor device 30 to the display of the selected folder list (see FIG. 3B).

If the switching of the display between the MP3 folder and the JPEG folder is commanded by operating the menu key 20a of the remote controller 20, the microcomputer 16 sends out a control signal to the OSD circuit 12 to display a list of JPEG folders (still picture folders) containing the JPEG files recorded in the optical disk on the left screen of the screen 30a of the monitor device 30 (see FIG. 3D). If the JPEG folder displayed on the left screen of the screen 30a of the monitor device 30 is selected by operating the cursor key 20b and the enter key 20c of the remote controller 20, the microcomputer 16 sends out a control signal to the OSD circuit 12 to display the selected JPEG folder in a selected folder list on the right screen of the screen 30a of the monitor device 30 (see FIG. 3E). If the JPEG file is contained in any MP3 folder, the MP3 folder is also displayed in the list of JPEG folders.

If the selected folder list displayed on the right screen of the screen 30a of the monitor device 30 is selected by operating the next skip key 20g of the remote controller 20, and the display of the JPEG file within the JPEG folder displayed on the right screen of the screen 30a of the monitor device 30 is commanded by operating the cursor key 20b and the enter key 20c of the remote controller 20, the microcomputer 16 sends out a control signal to the OSD circuit 12 to display the JPEG files within the selected JPEG folder on the right screen of the screen 30a of the monitor device 30 (see FIG. 3F). If the deletion of the JPEG file displayed on the right screen of the screen 30a of the monitor device 30 is commanded by operating the cursor key 20b and the clear key 20d of the remote controller 20, the microcomputer 16 sends out a control signal to the OSD circuit 12 to delete the selected JPEG file from the reproduction list. If the end of deletion of the JPEG file is commanded by operating the return key 20e of the remote controller 20, the microcomputer 16 sends out a control signal to the OSD circuit 12 to return the right screen of the screen 30a of the monitor device 30 to the display of the selected folder list (see FIG. 3B).

If the reproduction of the files within the selected MP3 and JPEG folders is commanded by operating the reproduction key 20h of the remote controller 20, the microcomputer 16 sends out a control signal to the servo circuit 6 to drive the spindle motor 4 to rotate the optical disk 2 and drive the sled motor 5 to move the optical pickup 3, thereby simultaneously reproducing the MP3 file and JPEG file not deleted from the reproduction list within the selected MP3 folder and JPEG folder.

Referring to a flowchart of FIG. 4, the operation of the disk reproducing apparatus according to one embodiment of the invention will be further described below.

If the setting of simultaneous reproduction of the menu screen is selected by operating the cursor key and the enter key of the remote controller, and the display of the MP3 folder is selected by operating the menu key of the remote controller, the operation proceeds from step S1 to step S2, where a list of MP3 folders containing the MP3 files recorded in the optical disk is displayed on the left screen of the monitor device at step S2, and then goes to step S3.

At step S3, it is determined whether or not the MP3 folder displayed on the left screen of the monitor device is selected by operating the cursor key and the enter key of the remote controller. If the MP3 folder displayed on the left screen of the monitor device is selected, the operation goes to step S4, or otherwise, the operation goes to step S5.

At step S4, the selected MP3 folder is displayed on a list of selected folders, on the right screen of the monitor device and the operation goes to step S5.

At step S5, it is determined whether or not the selected folder list displayed on the right screen of the monitor device is selected by operating the next skip key of the remote controller, and the display of the MP3 file within the MP3 folder displayed on the right screen is commanded by operating the cursor key and the enter key of the remote controller. If the display of the MP3 file within the MP3 folder is commanded, the operation goes to step S6, or if the display of the MP3 file within the MP3 folder is not commanded, the operation goes to step S11.

At step S6, the MP3 file within the selected MP3 folder is displayed on the right screen of the monitor device. Then, the operation goes to step S7.

At step S7, it is determined whether or not the deletion of the MP3 file displayed on the right screen of the monitor device is commanded by operating the cursor key and the clear key of the remote controller. If the deletion of the MP3 file is commanded, the operation goes to step S8, or if the deletion of the MP3 file is not commanded, the operation goes to step S9.

At step S8, the selected MP3 file is deleted from the reproduction file, and the operation goes to step S9.

At step S9, it is determined whether or not the end of deletion of the MP3 file is commanded by operating the return key of the remote controller. If the end of deletion of the MP3 file is commanded, the operation goes to step S10, or if the end of deletion of the MP3 file is not commanded, the operation goes back to step S7 to repeat the steps from step S7.

At step S10, the right screen of the monitor device is returned to the display of the selected folder list, the operation goes to step S11.

At step S11, it is determined whether or not the switching of the display between the MP3 folder and the JPEG folder is commanded by operating the menu key of the remote controller. If the switching of the display between the MP3 folder and the JPEG folder is commanded, the operation goes to step S12, or if the switching of the display between the MP3 folder and the JPEG folder is not commanded, the operation goes back to step S3 to repeat the steps from step S3.

At step S12, a list of JPEG folders containing the JPEG files recorded in the optical disk is displayed on the left screen of the monitor device, and the operation goes to step S13.

At step S13, it is determined whether or not the JPEG folder displayed on the left screen of the monitor device is selected by operating the cursor key and the enter key of the remote controller. If the JPEG folder displayed on the left screen of the monitor device is selected, the operation goes to step S14, or if the JPEG folder displayed on the left screen of the monitor device is not selected, the operation goes to step S15.

At step S14, the selected JPEG folder is displayed in a selected folder list on the right screen of the monitor device, and the operation goes to step S15.

At step S15, it is determined whether or not the selected folder list displayed on the right screen of the monitor device is selected by operating the next skip key of the remote controller, and the display of the JPEG file within the JPEG folder displayed on the right screen is commanded by operating the cursor key and the enter key of the remote controller. If the display of the JPEG file within the JPEG folder is commanded, the operation goes to step S16, or if the display of the JPEG file within the JPEG folder is not commanded, the operation goes to step S21.

At step S16, the JPEG files within the selected JPEG folder is displayed on the right screen of the monitor device, the operation goes to step S17.

At step S17, it is determined whether or not the deletion of the JPEG file displayed on the right screen of the monitor device is commanded by operating the cursor key and the clear key of the remote controller. If the deletion of the JPEG file is commanded, the operation goes to step S18, or if the deletion of the JPEG file is not commanded, the operation goes to step S19.

At step S18, the selected JPEG file is deleted from the reproduction list, and the operation goes to step S19.

At step S19, it is determined whether or not the end of deletion of the JPEG file is commanded by operating the return key of the remote controller. If the end of deletion of the JPEG file is commanded, the operation goes to step S20, or if the end of deletion of the JPEG file is not commanded, the operation goes back to step S17 to repeat the steps from step S17.

At step S20, the right screen of the monitor device is returned to the display of the selected folder list, and the operation goes to step S21.

At step S21, it is determined whether or not the reproduction is commanded by operating the reproduction key of the remote controller. If the reproduction is commanded, the operation goes to step S22, or if the reproduction is not commanded, the operation goes back to step S13 to repeat the steps from step S13.

At step S22, the MP3 file and JPEG file not deleted from the reproduction list within the selected MP3 folder and JPEG folder are simultaneously reproduced, and the procedure is ended.

### SECOND EMBODIMENT

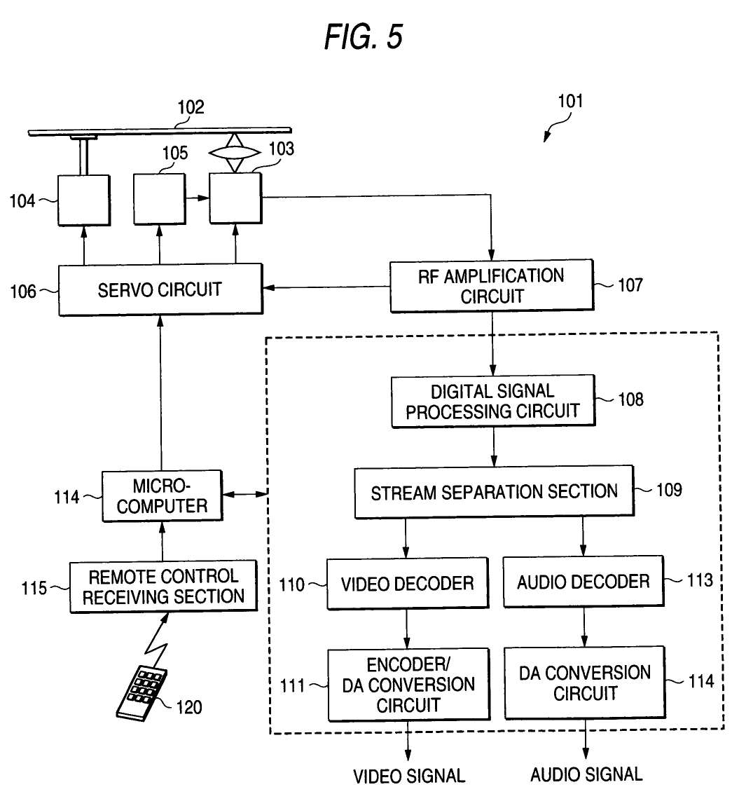

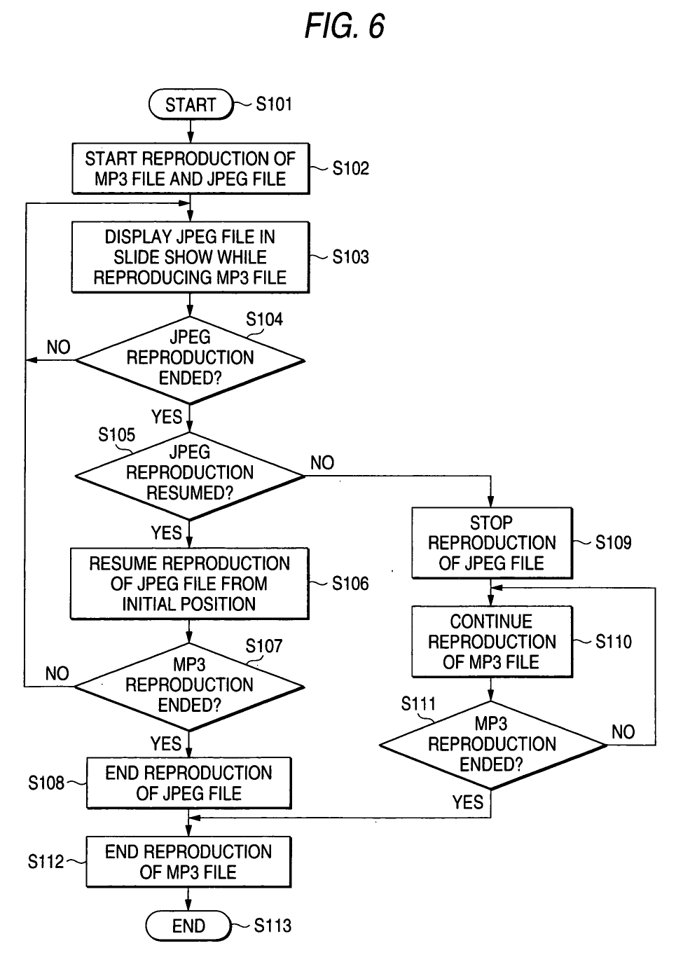

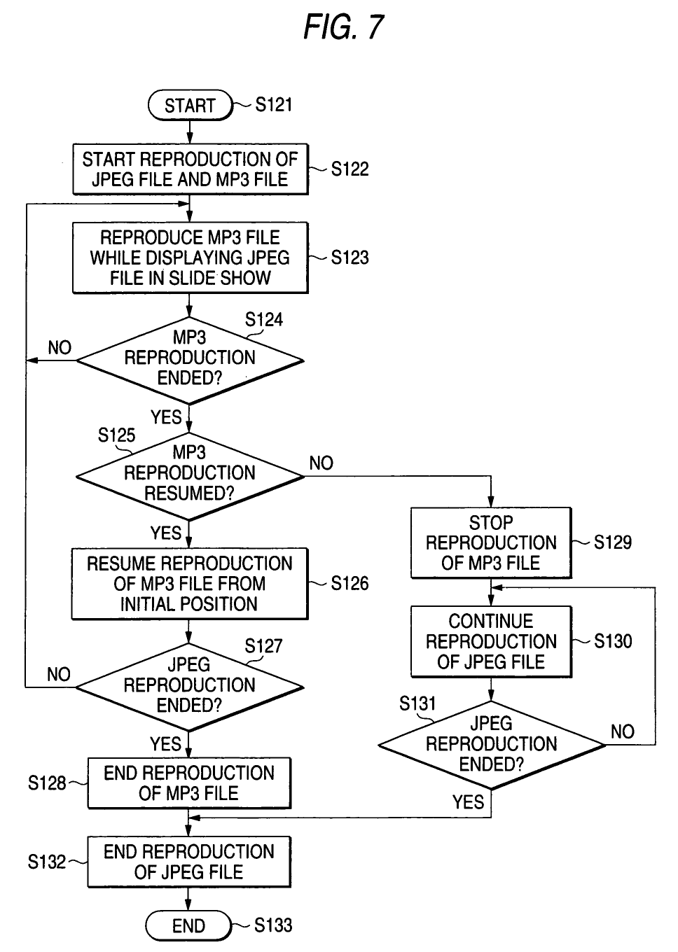

FIG. 5 is a block diagram showing the configuration of a disk reproducing apparatus according to another embodiment of the invention. FIG. 6 is a flowchart showing the operation of the disk reproducing apparatus according to another embodiment of the invention. FIG. 7 is a flowchart showing the operation of the disk reproducing apparatus according to another embodiment of the invention.

Referring to the block diagram of FIG. 5, first of all, the configuration of the disk reproducing apparatus according to another embodiment of the invention will be described below.

The disk reproducing apparatus 101 comprises an optical pickup 103 for reading the information data recorded in an optical disk 102 by applying a laser light onto a record face of the optical disk 102 and detecting its reflected light, a spindle motor 104 for rotating the optical disk 102, a sled motor 105 for moving the optical pickup 103 in the radial direction of the optical disk 102, a servo circuit 106 for making the servo control for the rotation rate of the optical disk 102, the servo control for the rotation direction and rotation speed of the sled motor 105, the servo control for the tracking of the optical pickup 103 based on a tracking error signal detected by the optical pickup 103, and the servo control for the focus of the optical pickup 103 based on a focus error signal detected by the optical pickup 103 by driving the spindle motor 104, an RF amplification circuit 107 for amplifying an RF (Radio Frequency) signal of the information data read by the optical pickup 103, a digital signal processing circuit 108 for converting the information data of an analog signal into a digital signal by detecting the RF signal of the information data amplified by the RF amplification circuit 107 in synchronism with a reference clock and demodulating the information data converted into the digital signal to correct an error of the demodulated information data, a stream separation section 109 for separating each bit stream of a video signal and an audio signal of the information data, a video decoder 110 for decoding the video signal into the original information data by expanding the video signal of the information data compressed in accordance with a predetermined compression method such as a JPEG method, an encoder/DA conversion circuit 111 for encoding the video signal of the digital signal decoded by the video decoder 110 into the video signal in accordance with a predetermined signal method such as an NTSC (National Television System Committee) method, and converting the encoded video signal of the digital signal into the analog signal, an audio decoder 112 for decoding the audio signal into the original digital signal by expanding the audio signal of the information data compressed in accordance with a predetermined compression method such as an MP3 method, a DA conversion circuit 113 for converting the decoded audio signal of the digital signal into the analog signal, a microcomputer 114 for controlling the entire system of the disk reproducing apparatus 101, and a remote control receiving section 115 for receiving a remote control signal of an infrared signal transmitted from the remote controller 120 and converting it into a predetermined electrical signal.

The operation of the disk reproducing apparatus as constituted above will be described below.

If the reproduction of the MP3 file (audio file) and the JPEG file (still picture file) recorded in the optical disk 102 is commanded by operating an operation key of the remote controller, the microcomputer 114 sends out a control signal to the servo circuit 106 to drive the spindle motor 104 to rotate the optical disk 102, and drive the sled motor 105 to move the optical pickup 103 to read the MP3 file and the JPEG file recorded in the optical disk, starting the reproduction of the MP3 file and the JPEG file to reproduce the JPEG file recorded in the optical disk 102 while reproducing the MP3 file recorded in the optical disk 102, and display the reproduced JPEG file in the slide show.

And when the reproduction of the JPEG file recorded in the optical disk 102 is ended ahead during the reproduction of the MP3 file and the JPEG file, the resumption of the reproduction of the JPEG file recorded in the optical disk 102 is commanded by operating an operation key of the remote controller, whereby the microcomputer 114 resumes the reproduction of the JPEG file recorded in the optical disk 102 from the initial position to continue the slide show of the JPEG file by repeating the reproduction of the JPEG file recorded in the optical disk 102 until the reproduction of the MP3 file recorded in the optical disk 102 is ended. When the reproduction of the JPEG file recorded in the optical disk 102 is ended, the reproduction of the MP3 file alone recorded in the optical disk 102 is continued if the resumption of the reproduction of the JPEG file is not commanded.

Also, when the reproduction of the MP3 file recorded in the optical disk 102 is ended ahead during the reproduction of the MP3 file and the JPEG file, the resumption of the reproduction of the MP3 file recorded in the optical disk 102 is commanded by operating an operation key of the remote controller, whereby the microcomputer 114 resumes the reproduction of the MP3 file recorded in the optical disk 102 from the initial position to continue the reproduction of the MP3 file recorded in the optical disk 102 by repeating the reproduction of the MP3 file recorded in the optical disk 102 until the reproduction of the JPEG file recorded in the optical disk 102 is ended. When the reproduction of the MP3 file recorded in the optical disk 102 is ended, the slide show of the JPEG file is continued by reproducing the JPEG file alone recorded in the optical disk 102, if the resumption of the reproduction of the MP3 file is not commanded.

Referring to a flowchart of FIG. 6, the operation of the disk reproducing apparatus according to another embodiment of the invention will be described below.

If the reproduction of the MP3 file and the JPEG file recorded in the optical disk is commanded by operating an operation key of the remote controller, the operation proceeds from step S101 to step S102, where the reproduction of the MP3 file and the JPEG file recorded in the optical disk is started. Then, the operation goes to step S103.

At step S103, the JPEG file is displayed in the slide show by reproducing the JPEG file recorded in the optical disk while reproducing the MP3 file recorded in the optical disk ate step S102. Then, the operation goes to step S104.

At step S104, it is determined whether or not the reproduction of the JPEG file recorded in the optical disk is ended. If the reproduction of the JPEG file recorded in the optical disk is ended, the operation goes to step S105, or if the reproduction of the JPEG file recorded in the optical disk is not ended, the operation goes back to step S103 to repeat the steps from step S103.

At step S105, it is determined whether or not the resumption of the reproduction of the JPEG file recorded in the optical disk is commanded. If the resumption of the reproduction of the JPEG file recorded in the optical disk is commanded, the operation goes to step S106, or if the resumption of the reproduction of the JPEG file recorded in the optical disk is not commanded, the operation goes to step S109.

At step S106, the reproduction of the JPEG file recorded in the optical disk is resumed from the initial position. Then, the operation goes to step S107.

At step S107, it is determined whether or not the reproduction of the MP3 file recorded in the optical disk is ended. If the reproduction of the MP3 file recorded in the optical disk is ended, the operation goes to step S108, or if the reproduction of the MP3 file recorded in the optical disk is not ended, the operation goes back to step S103 to repeat the steps from step S103.

At step S108, the reproduction of the JPEG file recorded in the optical disk is ended. Then, the operation goes to step is S112.

At step S109, the reproduction of the JPEG file recorded in the optical disk is stopped. Then, the operation goes to step S110.

At step S110, the reproduction of the MP3 file recorded in the optical disk is continued. Then, the operation goes to step S111.

At step S111, it is determined whether or not the reproduction of the MP3 file recorded in the optical disk is ended. If the reproduction of the MP3 file recorded in the optical disk is ended, the operation goes to step S112, or if the reproduction of the MP3 file recorded in the optical disk is not ended, the operation goes back to step S110 to repeat the steps from step S110.

At step S112, the reproduction of the MP3 file recorded s in the optical disk is ended. Then, the operation goes to step S113 and this procedure is ended.

Referring to a flowchart of FIG. 7, the operation of the disk reproducing apparatus according to another embodiment of the invention will be described below.

If the reproduction of the JPEG file and the MP3 file recorded in the optical disk is commanded by operating an operation key of the remote controller, the operation proceeds from step S121 to step S122, where the reproduction of the JPEG file and the MP3 file recorded in the optical disk is started at step S122. Then, the operation goes to step S123.

At step S123, the MP3 file recorded in the optical disk is reproduced while the JPEG file is displayed in the slide show by reproducing the JPEG file recorded in the optical disk. Then, the operation goes to step S124.

At step S124, it is determined whether or not the reproduction of the MP3 file recorded in the optical disk is ended. If the reproduction of the MP3 file recorded in the optical disk is ended, the operation goes to step S125, or if the reproduction of the MP3 file recorded in the optical disk is not ended, the operation goes back to step S123 to repeat the steps from step S123.

At step S125, it is determined whether or not the resumption of the reproduction of the MP3 file recorded in the optical disk is commanded. If the resumption of the reproduction of the MP3 file recorded in the optical disk is commanded, the operation goes to step S126, or if the resumption of the reproduction of the MP3 file recorded in the optical disk is not commanded, the operation goes to step S129.

At step S126, the reproduction of the MP3 file recorded in the optical disk is resumed from the initial position. Then, the operation goes to step S127.

At step S127, it is determined whether or not the reproduction of the JPEG file recorded in the optical disk is ended. If the reproduction of the JPEG file recorded in the optical disk is ended, the operation goes to step S128, or if the reproduction of the JPEG file recorded in the optical disk is not ended, the operation goes back to step S123 to repeat the steps from step S123.

At step S128, the reproduction of the MP3 file recorded in the optical disk is ended. Then, the operation goes to step S132.

At step S129, the reproduction of the MP3 file recorded in the optical disk is stopped. Then, the operation goes to step S130.

At step S130, the slide show of the JPEG file recorded in the optical disk is continued. Then, the operation goes to step S131.

At step S131, it is determined whether or not the reproduction of the JPEG file recorded in the optical disk is ended. If the reproduction of the JPEG file recorded in the optical disk is ended, the operation goes to step S132, or if the reproduction of the JPEG file recorded in the optical disk is not ended, the operation goes back to step S130 to repeat the steps from step S130.

At step S132, the reproduction of the JPEG file recorded in the optical disk is ended. Then, the operation goes to step S133 and this procedure is ended.

Though the best mode for carrying out the invention has been detailed above, it will be apparent to those skilled in the art that various changes or modifications may be made thereto without departing from the spirit or scope of the invention. For example, the disk reproducing apparatus has been described in which the MP3 folder and the JPEG folder recorded in the optical disk are selected, and the MP3 file and the JPEG file are reproduced simultaneously. However, the invention is not limited to the optical disk, but may be an information reproducing apparatus for simultaneously reproducing the audio file and the still picture file recorded in the recording medium such as memory card capable of recording the audio file such as MP3 file and the still picture file such as JPEG file.

Also, though the MP3 folder is selected ahead and then the JPEG folder is selected, the JPEG folder may be selected ahead and then the MP3 folder may be selected.

Also, though the undesired file for reproduction is deleted from the list of files within the folder in the selected reproduction list, the desired file for reproduction may be selected from the list of files within the folder in the selected reproduction list.

For example, the disk reproducing apparatus for reproducing the MP3 file and the JPEG file recorded in the optical disk has been described. However, the invention is not limited to the optical disk, but may be an information reproducing apparatus for reproducing the audio file and the still picture file recorded in the recording medium capable of recording the audio file such as MP3 file and the still picture file such as JPEG file.

What is claimed is:

1. A disk reproducing apparatus that reproduces an MP3 file and a JPEG file recorded in an optical disk, comprising:
a reading unit that reads an MP3 folder and a JPEG folder including an MP3 file and a JPEG file recorded in the optical disk;
a first display unit that displays a list of the MP3 folder and a list of the JPEG folder read by the reading unit on a left screen;
a first selection unit that selects an MP3 folder and a JPEG folder from the list of the MP3 folder and the list of the JPEG folder displayed by the first display unit;
a second display unit that displays the MP3 folder and the JPEG folder selected by the first selection unit on a right screen;
a second selection unit that selects the MP3 folder and the JPEG folder displayed by the second display unit;
a third display unit that displays an MP3 file and a JPEG file within the MP3 folder and the JPEG folder selected by the second selection unit on the right screen;
a third selection unit that selects the MP3 file and the JPEG file displayed by the third display unit;
a deletion unit that deletes the MP3 file and the JPEG file selected by the third selection unit from a reproduction list; and
a reproduction unit that reproduces simultaneously an MP3 file and a JPEG file not deleted from the reproduction list by the deletion unit within the MP3 folder and the JPEG folder selected by the first selection unit.

2. A disk reproducing apparatus that reproduces simultaneously an MP3 file and a JPEG file recorded in an optical disk such as a DVD, comprising:
a reproduction unit that reproduces the MP3 file and the JPEG file recorded in the optical disk;
a display unit that displays the JPEG file reproduced by the reproduction unit in a slide show while reproducing the MP3 file recorded in the optical disk; and
a continuation unit that continues the slide show of the JPEG file by resuming a reproduction of the JPEG file recorded in the optical disk from an initial position to repeat the reproduction of the JPEG file recorded in the optical disk until a reproduction of the MP3 file recorded in the optical disk is ended, if the reproduction of the JPEG file recorded in the optical disk is ended during a reproduction of the MP3 file and the JPEG file, and continuing the reproduction of the MP3 file by resuming the reproduction of the MP3 file recorded in the optical disk from the initial position to repeat the reproduction of the MP3 file recorded in the optical disk until the reproduction of the JPEG file recorded in the optical disk is ended, if the reproduction of the MP3 file recorded in the optical disk is ended.

3. An information reproducing apparatus that reproduces an audio file and a still picture file recorded in a recording medium capable of recording the audio file and the still picture file, comprising:
a reading unit that reads a audio folder and a still picture folder containing an audio file and a still picture file recorded in the recording medium;
a first display unit that displays a list of an audio folder and a list of a still picture folder read by the reading unit on a left screen;
a first selection unit that selects an audio folder and a still picture folder from the list of the audio folder and the list of the still picture folder displayed by the first display unit;
a second display unit that displays the audio folder and the still picture folder selected by the first selection unit on a right screen; and
a reproduction unit that reproduces simultaneously the audio file and the still picture file within the audio folder and the still picture folder selected by the first selection unit.

4. The information reproducing apparatus according to claim 3, further comprising:
a second selection unit that selects the audio folder and the still picture folder displayed on the right screen by the second display unit; and
a third display unit that displays the audio file and the still picture file within the audio folder and the still picture folder selected by the second selection unit on the right screen.

5. The information reproducing apparatus according to claim 3, further comprising:
a third selection unit that selects the audio file and the still picture file displayed by the third display unit; and
a deletion unit that deletes the audio file and the still picture file selected by the third selection unit from a reproduction list, wherein
the reproduction unit reproduces simultaneously an audio file and a still picture file not deleted from the reproduction list by the deletion unit within the audio folder and the still picture folder selected by the first selection unit.

6. An information reproducing apparatus that reproduces simultaneously an audio file and a still picture file recorded in a recording medium capable of recording the audio file and the still picture file, comprising:
a reproduction unit that reproduces the audio file and the still picture file recorded in the recording medium;
a display unit that displays the still picture file reproduced by the reproduction unit in a slide show while reproducing the audio file recorded in the recording medium; and
a continuation unit that continues the slide show of the still picture file by repeating a reproduction of the still picture file recorded in the recording medium until a reproduction of the audio file recorded in the recording medium is ended, if the reproduction of the still picture file recorded in the recording medium is ended during a reproduction of the audio file and the still picture file.

7. The information reproducing apparatus according to claim 6, wherein
the continuation unit resumes the reproduction of the still picture file recorded in the recording medium from an initial position, if the reproduction of the still picture file recorded in the recording medium is ended during the reproduction of the audio file and the still picture file.

8. An information reproducing apparatus that reproduces simultaneously an audio file and a still picture file recorded in a recording medium capable of recording the audio file and the still picture file, comprising:
a reproduction unit that reproduces the audio file and the still picture file recorded in the recording medium;
a display unit that displays the still picture file reproduced by the reproduction unit in a slide show while reproducing the audio file recorded in the recording medium; and
a continuation unit that continues a reproduction of the audio file by repeating the reproduction of the audio file recorded in the recording medium, until a reproduction of the still picture file recorded in the recording medium is ended, if the reproduction of the audio file recorded in the recording medium is ended during a reproduction of the audio file and the still picture file.

9. The information reproducing apparatus according to claim 8, wherein
the continuation unit resumes the reproduction of the audio file recorded in the recording medium from an initial position, if the reproduction of the audio file recorded in the recording medium is ended during the reproduction of the audio file and the still picture file.
